(19) United States
(12) Patent Application Publication
(10) Pub. No.: US 2010/0043168 A1
(43) Pub. Date: Feb. 25, 2010

(54) VEHICLE VACUUM SYSTEM

(76) Inventors: Clint Johnson, Dousman, WI (US); Steve Gapp, Dousman, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/197,250

(22) Filed: Aug. 23, 2008

(51) Int. Cl. B60S 1/64

(52) U.S. Cl. 15/313

(57) ABSTRACT

A central vacuum cleaner system for an automobile which comprises one or more portals located inside the passenger compartment of an automobile and/or in the space optimized canister located in the trunk or rear of the automobile Transitory tubing connects the one or more portals to the space optimized canister wherein debris is collected and stored. Debris can be placed directly in the portal or a hose and/or additional attachments may be attached to the portal. A portal cover covers the one or more portals blocking the portal when debris is not being placed directly in the portal or when no hose is attached. The central vacuum cleaner system may be powered using the automobile's battery or an external battery.

### FIELD OF INVENTION

This invention relates generally to the field of automobile accessories and more specifically to a central vacuum cleaner system to be installed in an automobile at the time of manufacturing.

### BACKGROUND

There have been many attempts in the prior art to develop an vehicle vacuum system designed to remain in an automobile; however, they have all focused on after-market systems which are purchased by a consumer and installed or used without any structural or design modifications to the automobile components. Since automobiles (e.g., all types of cars, trucks and other vehicles) vary greatly is size, design specification, power, interior features, frame, trunk space and passenger space, it is a problem to design a vacuum system which is optimized for all vehicles. It is particularly difficult to create a space-efficient, simply operated, mechanically reliable device without making any design modifications to the dashboard, trunk components, carpeting frame or other components of the automobile. However, the prior art has generally taught against making modifications to vehicle body components themselves and/or have required building of special compartments. Further, these designs have required complex retractable hosing, and have had limited ability to reach all areas of a passenger vehicle. They are expensive to manufacture both before-market and after-market. Many prior art attempts to develop a vehicle vacuum system have relied on complex and limiting configurations involving storage of a canister in a console portion between automobile seats, space-inefficient trunk components and expensive retractable hoses prone to malfunction,

For example, U.S. Patent Application No. 2004/0107528 (the '528 application) teaches an automobile vacuum which has canister built into a compartment between vehicle seats. “A retractable hose is fluidly connected to the vacuum canister. The hose is selectively retractable and extendable from a motorized reel. Both the vacuum and the reel are operable from a switch on a nozzle at the end of the hose. Cleaning solution from a tank can be selectively sprayed simultaneously with the vacuum operation.” A special compartment is required; the canister is small and the motor limits the strength of the suction. This design is not effective for picking up debris such as fast food wrappers.

The concealed and retractable hose taught by the '528 application is prone-to malfunctioning, as well as is costly. The hose is concealed under a pivotable and slidable cover in the rear seat of the automobile. The canister is not designed or adapted for mounting in the trunks of vehicles having variable dimensions. The canister is also not contoured to be space efficient.

U.S. Patent Application No. 2005/0066468 (the '468 application) teaches a “direct port” vacuum cleaning system with a canister disposed in the body of the automobile, in the console or in a side compartment. The canister of the '468 application is of limited power, and utilizes a “direct port” without transitory tubing that allows debris to be vacuumed and transported to a canister from within various locations of the vehicle. The '468 patent further states that it is an object of the invention to “provide a direct port vacuum cleaning system that may be easily removed and installed” thus indicating that it is intended as primarily an after-market product. The '468 application teaches a hose which may be stored in the trunk or boot of the vehicle until it is needed for use. The range of access to the passenger compartment for cleaning is limited by the location of the canister and length of the hose, which poses a serious limitation.

U.S. Pat. No. 7,231,686 teaches a vacuum cleaning system with a compact, retractable hose with interchangeable nozzles which is permanently mounted inside the passenger compartment in the existing console area between the seats. The hose and power cord which connects directly to the cigarette lighter of the vehicle can be retracted into the housing for storage. In addition, the vacuum system takes up space in the passenger compartment, it is also an after-market device, and it does not utilize trunk space, the space between the under-body of the vehicle, or battery power.

Systems in the prior art have been ineffective because the devices take up passenger compartment space and are limited in power and cleaning range. Additionally, vehicles vary greatly in size and style therefore one system is not compatible with all types of vehicles. Furthermore, such designs lack desired child-safety features.

It is desirable to have a central vacuum system for an automobile which is powered by the automobile's power system, is optimized for a particular vehicle design and utilizes both trunk space and space in between the body and passenger section of an automobile.

It is further desirable to have a vehicle vacuum system completely or partially powered by the vehicle battery.

It is further desirable to have a vacuum system capable of suctioning a wide range of debris found in cars, including but not limited to dust, dirt, pebbles, solid debris, food wrappers, cigarette butts, etc.

It is further desirable to have a vehicle vacuum system which can be offered by automobile manufacturers before-market, can be serviced by the automobile manufacture and offers minimal structural modifications to the interior components of a vehicle.

It is also desirable to generate continuing revenue from specialized components for a vehicle vacuum system.

### SUMMARY OF THE INVENTION

The present invention is a central vacuum cleaner system for an automobile which has a specially molded dash with vacuum portals, a detachable hose attachment, hinged door panels over vacuum portals (i.e., portal doors), a pressure sensitive switch which is activated by opening the portal door, a tubing system which passes between the floor and the outer body of the automobile, and a spatially optimized ceramic vacuum canister which is designed to take up minimum space and can be manufactured in various makes and models for different styles of automobiles.

### BRIEF DESCRIPTION OF THE DRAWINGS

FIG. 1 illustrates an exemplary embodiment of a central vacuum cleaner system for an automobile illustrating a canister and motor located in a trunk and accessed by transitory tubing.

FIG. 2 illustrates exemplary portals which may be placed in various panels within a vehicle.

FIG. 3 illustrates an exemplary connection between transitory tubing leading from a vacuum canister and a portal having a hinged door and pressure activated switch in the automobile dash board.

### GLOSSARY

As used herein, “space optimized canister” refers to a device designed to hold debris, be stored in the trunk or rear of an automobile and which optimizes space in all vehicle designs. Space optimized canisters may be in several variations to accommodated particular vehicle designs, sizes and consumer preferences relative to placement or trunk space.

As used herein, “hose” refers to a component used to vacuum debris or to selectively attach accessories for vacuuming debris.

As used herein, “debris” refers to any refuse such as dust, dirt, pebbles, cigarette butts, food wrappers, paper, food and crumbs.

As used herein, “transitory tubing” refers to tubing or other similar component which carries debris from the portal or hose to the space optimized canister.

As used herein, “portal cover” refers to a door, barrier or cover which pivots, slides or retracts in a manner to allow access to a portal to place debris or so that a hose may be inserted or attached.

As used herein, “pressure switch” refers to a component which activates, controls or-turns on a device by pressure such as ones commercially available from Ashcroft, Inc.

As used herein, “specially-molded panel” refers to a dash board or other automotive component which is machined or molded to accommodate one or more portals and/or portal cover.

As used herein, the term “after-market” refers to an installation of an automobile component after the automobile is manufactured and offered for sale or sold to a consumer.

As used herein, the term “before-market” refers to an installation of an automobile component before the automobile is manufactured and ready for sale to a consumer by the original equipment manufacturer.

As used herein, the term “vehicle” means any car, truck, utility vehicle or other vehicle known in the art.

### DETAILED DESCRIPTION OF EMBODIMENTS OF THE INVENTION

For the purpose of promoting an understanding of the present invention references are made in the text hereof to embodiments of a central vacuum cleaner system for a vehicle, only some of which are depicted in the figures. It should nevertheless be understood that no limitations on the scope of the invention are thereby intended. One of ordinary skill in the art will readily appreciate that modifications such as the dimensions, size, and shape of the components, alternate but functionally similar locations, and the inclusion of additional elements are deemed readily apparent and obvious to one of ordinary skill in the art, and all equivalent relationships to those illustrated in the drawings and described in the written description do not depart from the spirit and scope of the present invention. Some of these possible modifications are mentioned in the following description. Therefore, specific details disclosed herein are not to be interpreted as limiting, but rather as a representative basis for teaching one of ordinary skill in the art to employ the present invention in virtually any appropriately detailed apparatus or manner.

It should be understood that the drawings are not necessarily to scale, emphasis instead being placed upon illustrating the principles of the invention. In addition, in the embodiments depicted herein, like reference numerals in the various drawings refer to identical or near identical structural elements.

Moreover, the term “substantially” or “approximately” as used herein may be applied to modify any quantitative representation that could permissibly vary without resulting in a change in the basic function to which it is related.

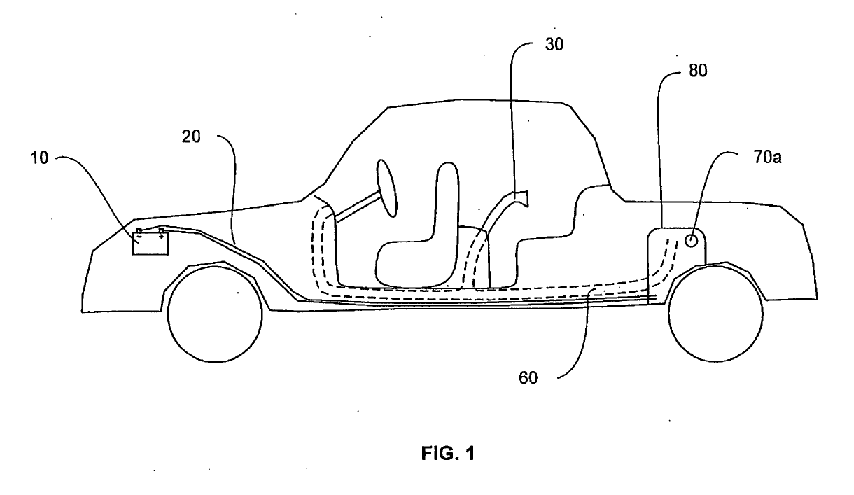

Referring now to the drawings, FIG. 1 illustrates an exemplary embodiment of a central vacuum cleaner system for an automobile. A space optimized canister 80 is located in the trunk of the automobile. The space optimized canister collects and stores debris until it is emptied by the user. In the embodiment shown the space optimized canister 80 is curved to complement the shape of the automobile wheel. In other embodiments, the space optimized canister 80 may be of a different shape suited for placement in a different type of vehicle, for example, in the rear compartment of a sport utility vehicle.

Transitory tubing 60 is ductwork which carries debris from a portal(s) and/or hose(s) to the space optimized canister 80. The transitory tubing 60 travels beneath the seats of the automobile. In the embodiment shown, there is a single set of transitory tubing; however, in other embodiments there may be multiple sets of transitory tubing. Transitory tubing 60 may consist of tubing or pipe and may be made of rigid or flexible plastic, stainless steel, or any other material. Additionally, the transitory tubing may be comprised of a nonflammable material and may be modular and/or segmented for different size automobiles.

Also shown are a power source 10 and power source wiring 20 which connects the power source 10 to the space optimized canister 80. In the embodiment shown, power source wiring 20 connects the vacuum and space optimized canister 80 to the automobile's 12 volt battery. In other embodiments, power source wiring 20 connects the vacuum to the automobile's battery which has a voltage greater or lesser than 12 volts. Still, in other embodiments, the power source is a battery other than the battery of the automobile or is a combination of the battery of the automobile and another battery.

FIG. 1 further illustrates an one embodiment of a hose 30 which is a component used to vacuum debris or to which accessories may be selectively attached for vacuuming debris. Hose 30 may be collapsible, coiled, and/or retractable for easy storage and may or may not be selectively attached to a portal. The hose 30 may be attached to a portal by threading, clamping, the fitting together of corresponding molded pieces or by any other means known in the art. Additionally, the hose may be adapted to receive optional nozzles and attachments for detail cleaning of crevices or contouring.

In the embodiment shown, the space optimized canister 80 contains a portal 70a to which a hose may be attached for removing debris from the trunk or other nearby areas. Additional portal(s) are located inside the passenger compartment of the vehicle, for example the front dash, center console, floor, etc.

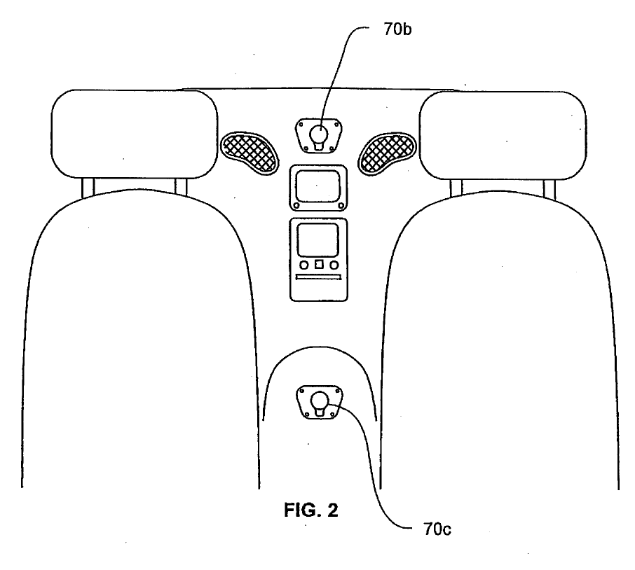

FIG. 2 illustrates an exemplary embodiment of portals 70b and 70c which are located on the front dash and the center console (between front passenger seats) facing the back seat of the automobile respectively. The portals 70b and 70c are located in specially molded panels. In the embodiment shown, the specially molded panels are the front dash and the center console and each specially molded panel contains only one portal; however, in other embodiments a specially molded panel may contain multiple portals. In other embodiments, the one or more portals may be located in alternate positions such as the top of the center console. Portals may also be located on the floor of the automobile.

In the embodiment shown, portals 70b and 70c have a hinged portal cover which covers them when debris is not being placed inside or when a hose is not attached to the portal; the portal cover flips up to allow debris to be placed inside the portal or to attach a hose. In other embodiments, the portal cover is not hinged, but rather pivots, slides, or retracts in a manner which allows access to the portal to place debris or so that a hose may be inserted or attached.

In the embodiment shown, the portal cover operates as a pressure switch when flipped up and/or a hose attached. Additional options/safety features may include that the central vacuum cleaner system may be turned on only when the ignition of the automobile is on (or in the alternative off), when a separate key is inserted or when a childproof switch is flipped.

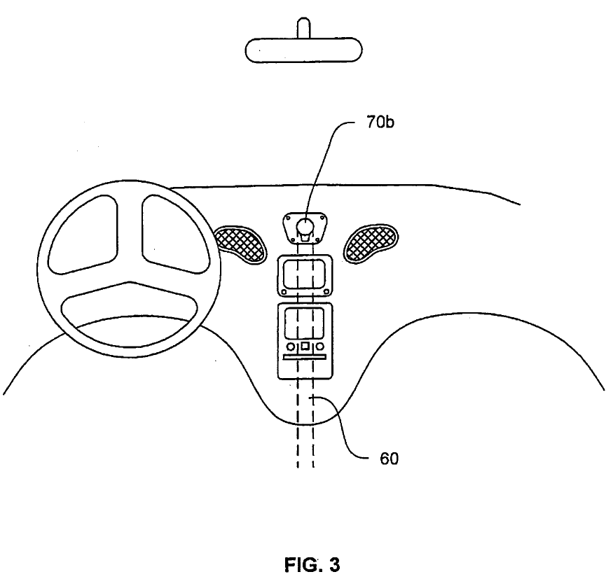

FIG. 3 illustrates an exemplary embodiment of portal 70b molded into the front dash of an automobile. FIG. 3 further illustrates transitory tubing 60 which is connected to the underside of the portal 70b and which travels behind the front dash and under the floorboards to the space optimized canister located in the trunk of the car (not shown).

1. A vehicle vacuum apparatus comprising:
a space-optimized canister;
transitory tubing which connects said space optimized canister to one or more portals located in a panel in the vehicle interior;
and a power sources to provide suction through said hose and transitory tubing;
a hose which connects to said transitory tubing through said one or more portals having components which activate said power source.

2. The vehicle vacuum system of claim 1 wherein said the visibility of said transitory tubing is minimized by locating said transitory tubing at least partially between the outer frame of the car and the panels comprising the interior passenger compartment.

3. The vehicle vacuum system of claim 1 wherein said portals are installed after market.

4. The vehicle vacuum system of claim 1 wherein said portals are installed before market.

5. The vehicle vacuum system of claim 1 wherein said power source is powered by the battery of the automobile.

6. The vehicle vacuum system of claim 1 which further includes an aperture in a panel proximate to the canister in the vehicle trunk.

7. The vehicle vacuum system of claim 1 which further includes transitory tubing and a space efficient canister which are heat and moisture resistant.

8. The vehicle vacuum system of claim 1 which is powered by a motor having from 12 or volts 100 volts and which is sufficient to create a suction capable of suctioning solid debris.

8. The vehicle vacuum system of claim 1 in which said portals have hinged covers which activate a power source when a hose causes the portal covers to pivot along the line of motion of the hinges,

9. A method for constructing a vehicle vacuum system comprising the steps of:
Installing a space-optimized canister;
Installing transitory tubing which connects said space optimized canister to one or more portals located in a panel in the vehicle interior;
Connecting said space optimized canister to a power sources to provide suction through said hose and transitory tubing;
Creating one or more portals in a the internal panels of a vehicle capable of receiving one end of said transitory tubing and one end of a selectively attached hose;
Adapting said one or more portals with a pressure sensitive component which activates the power of a motor to create a suction force to pull debris through said tube and through said transitory tubing to said space-efficient canister;
Connecting a hose to one or more portals having components which activate said power source.

10. The vehicle vacuum installation method of claim 9 wherein said the visibility of said transitory tubing is minimized by locating said transitory tubing at least partially between the outer frame of the car and the panels comprising the interior passenger compartment.

11. The vehicle vacuum installation method of claim 9 wherein said portals are installed after market.

12. The vehicle vacuum installation method of claim 9 wherein said portals are installed before market.

13. The vehicle vacuum installation method of claim 9 wherein said power source is powered by the battery of the automobile.

14. The vehicle vacuum installation method of claim 9 which further includes an aperture in a panel proximate to the canister in the vehicle trunk.

15. The vehicle vacuum installation method of system of claim 9 which further includes transitory tubing and a space efficient canister which are heat and moisture resistant.

16. The vehicle vacuum system of claim 9 which is powered by a motor having from 12 or volts 120 volts and which is sufficient to create a suction capable of suctioning solid debris selected from a group consisting of paper, cigarette butts, pet refuse, dust, wrappers, candy, small food debris, crumbs, pet hair, ashes, pebbles, mud, spilled liquids, wet soil and dry soil.

17. The vehicle vacuum system of claim 9 in which said portals have hinged covers which activate a power source when a hose causes the portal covers to pivot along the line of motion of the hinges,

18. A vehicle vacuum apparatus comprising:
a space-optimized canister;
transitory tubing which connects said space optimized canister to one or more portals located in a panel in the vehicle interior, said one or more portals have hinged covers which activate a power source when a hose causes the portal covers to pivot along the line of motion of the hinges,
and a power sources to provide suction through said hose and transitory tubing, said transitory tubing is minimized by locating said transitory tubing at least partially between the outer frame of the car and the panels comprising the interior passenger compartment;
a hose which connects to said transitory tubing through said one or more portals having components which activate said power source; and
an aperture in a panel proximate to the canister in the vehicle trunk.

19. The vehicle vacuum system of claim 18 which further includes transitory tubing and a space efficient canister which are heat and moisture resistant.

20. The vehicle vacuum system of claim 18 which is powered by a motor having from 12 or volts 120 volts and which is sufficient to create a suction capable of suctioning solid debris.
